(19) United States
(12) Patent Application Publication
(10) Pub. No.: US 2026/0194762 A1
(43) Pub. Date: Jul. 9, 2026

(54) LOW VISION ASSISTIVE MONOCULAR DEVICE

(71) Applicant: Renew Optics, Inc., San Francisco, CA (US)

(72) Inventor: Michelle C. Hua, San Francisco, CA (US)

(21) Appl. No.: 19/015,382

(22) Filed: Jan. 9, 2025

(51) Int. Cl. G02B 27/02

(52) U.S. Cl. CPC G02B 27/026; G02B 27/025

(57) ABSTRACT

A monocular apparatus configured to receive images and display enhanced images is provided. The monocular apparatus includes a housing having length less than 100 millimeters, the housing comprising a camera module with resolution of or exceeding 50 megapixels, a printed circuit board array configured to receive image information from the camera module and provide enhanced images, and a display element configured to receive the enhanced images and display the enhanced images.

### BACKGROUND OF THE INVENTION

### Field of the Invention

The present invention generally relates to the field of optical devices, and more specifically to optical devices used to assist the visually impaired.

### Description of the Related Art

Adults over the age of 65 make up at least 65 to 75 percent of the low vision population. Those with vision issues have typically been offered stronger and stronger eyewear, such as eyeglasses, that in many cases may provide inadequate vision compensation in all, or even many, situations encountered. Additionally, some individuals may prefer not to wear eyeglasses, and vision assistance such as contact lenses may be inadequate and/or unavailable depending on a patient's optical prescription. Some optical issues or visual impairments may be difficult or impossible to successfully treat or compensate for using conventional eyewear or contact lenses. In some cases surgery may be appropriate and adequate, but in other cases, even surgery may not sufficiently address the issue.

Certain accommodations or courses of action have been provided for the visually impaired. One improvement to help low-vision people read and watch television entails use of closed circuit televisions (CCTVs) in cooperation in some instances with separate computer-based systems to project text and images onto large monitors or screens. The last decade or so has seen additional development of new camera and display technologies to address and assist persons with low vision. However, such systems can be expensive, cumbersome, and are fixed or offer highly limited mobility.

One prior method to address vision impairment employs a smartphone with a virtual reality (VR) lens-based headset or Head-Mounted Display (HMD) specifically designed for low vision individuals. For a variety of reasons including ease of use, ability to address complex vision issues, and so forth, typical consumer VR and mixed-reality (MR) headsets on the market today are minimally usable or completely unusable for many low-vision users. Most available consumer VR/MR headsets today are only designed to add digital content to the user's view rather than allowing a low-vision user to magnify or enhance his real-world view. Such enhancement of real world visuals is rarely if ever a feature that makes sense for gaming, entertainment, productivity or other typical uses of consumer VR/MR (Virtual Reality/Mixed Reality) headsets.

In the last five or six years, developments in smartphones, high-resolution cameras, processing capabilities, and camera software have brought about the introduction of headsets addressing low vision issues. Such devices include the use of smartphones combined with VR lenses. Video passthrough uses a camera to record user surroundings and sends the video feed to the headset. The user is then able to see a video live feed of her surroundings in a headset environment. With smartphone and VR lens-based headsets directed to low-vision individuals, the headset positions the camera of the smartphone in front of the user's eyes to capture a real-time video feed of the user's physical surroundings. The device then projects the video feed as shown on the smartphone display to the user's eyes via VR lenses. These VR lenses provide a large field of view (FOV) (e.g., 70 degrees) and can provide an enjoyable visual experience. With VR lenses, the user can still see large areas in front of them even at high magnification levels. This video passthrough technology with magnification is then combined with various software enhancements, such as adjustable brightness, heavy color saturation, and contouring, to help the low-vision user better see her surroundings.

Video passthrough technology can be somewhat limited in assisting users in navigating their environments. They tend to be bulky, heavy, and uncomfortable and tend to heat the face and temples. Such devices can leave marks and skin rashes. Due to the weight of these devices, they can cause neck, shoulder, and back pain and injuries, of particular concern to elderly users. Additionally, the aesthetics of passthrough devices are not to the liking of all persons. To achieve high resolution at high magnification levels, current technology requires a large boxlike structure housing a smartphone in front of the user's face so that the smartphone's high mega-pixel (MP) mini camera can be incorporated into the HMD form factor. Further, complaints about the number of steps to employ the device, both putting on and taking off, are common.

An alternate form of video passthrough uses a non-smartphone camera on the outside of the headset to record user surroundings and send visual images to the headset. The user is then able to see a video live feed of his surroundings in a realistic way, even though he is in a headset environment. However, external cameras tend to add to the bulkiness and weight of the device.

Other solutions have been introduced, such as smart glasses specifically directed to blind and low-vision users. Such smart glasses omit displays but employ external cameras that capture images of the user's surroundings. These smart glasses employ computer vision artificial intelligence (AI) to analyze the image and some can audibly describe the “scene” to the user. For example, a user trying to leave a store may have trouble differentiating between the door and a window. When prompted to analyze the surroundings, AI may “tell” the user “there is a door to your left, and two large windows on either side of the door.” These types of smart glasses can be inadequate for more complex tasks or assessments.

Smart glasses with Gen AI integration that describe the user's surroundings via audio are less than ideal when the user simply wants to view her environment without audio commentary. Turning the functionality on and off can be difficult, particularly for older users, and certain smart glasses offer a simple on or off audio functionality selection. Additionally, some persons express issues with the appearance of these devices. Further, audio-only blind and low-vision smart glasses require use of passthrough technology where a camera must be positioned in front of the eye. The display and lens must also be positioned in front of the eye, resulting in a bulky or awkward arrangement.

Another previous design seeking to address the vision impaired consists of a monocular telescope that may be either optical or an optical-plus-digital hybrid. Low vision monocular telescopes differ from regular vision monocular telescopes in that they are designed to allow the user to see objects up close and far away. However, the advantage of low vision monocular telescopes diminishes as the user's vision changes and/or degrades. Also, when vision degrades, dimness is a common issue, and higher brightness is necessary to see well. But excessive brightness settings tend to dissuade users when employing monocular telescopes in bright sunlight or in brightly lit rooms.

One of the more significant drawbacks of monocular telescopes is the small field of view (FOV). Most small, lightweight handheld monocular telescopes provide narrow FOVs, such as between five and eight degrees, especially at high magnification levels. Users complain of having to “hunt” to find the object that they are trying to see. Users also become frustrated when they see only a part of a sentence or even just part of one word when reading.

With these varying options, each of differing complexity, those of advancing age can have difficulty engaging with and operating the foregoing devices and thus may be unable to successfully navigate electronics and optical arrangements that are challenging to operate and employ.

It would therefore be beneficial to provide an assistive device readily usable by all persons including those of advanced age with visual impairments that improves on designs previously available.

### SUMMARY OF THE INVENTION

The present design includes a monocular apparatus configured to receive images and display enhanced images, comprising a housing having length less than 100 millimeters, the housing comprising a camera module with resolution of or exceeding 50 megapixels, a printed circuit board array configured to receive image information from the camera module and provide enhanced images, and a display element configured to receive the enhanced images and display the enhanced images.

Alternately, the present design includes a monocular viewing apparatus configured to receive images and display enhanced images. The monocular viewing apparatus comprises a housing having length less than 100 millimeters, the housing comprising a camera module, a printed circuit board array configured to receive image information from the camera module and provide enhanced images, a display element configured to receive the enhanced images and display the enhanced images, and audio components connected to the printed circuit board array.

According to another embodiment, there is provided an apparatus comprising a housing having length less than 100 millimeters. The housing comprises a camera module having a resolution of at least 50 megapixels, a printed circuit board array configured to receive image information from the camera module and provide enhanced images, and a display element configured to receive the enhanced images and display the enhanced images. The apparatus further comprises an external computing device connectable to the printed circuit board array and configured to enhance video image information specific to a user.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 is a representation of one embodiment of the present design;

FIG. 2 illustrates components of the current design including the electrical components provided on a printed circuit board assembly; and

FIG. 3 is an exploded view of one embodiment of the current design.

### DETAILED DESCRIPTION

In this document, the words “embodiment,” “variant,” and similar expressions refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean serving as an example, instance, or illustration. Any embodiment variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

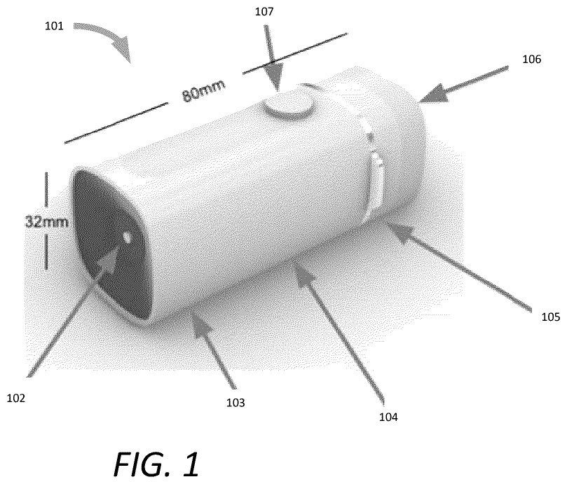

The present design is a visual assistance device having a small form factor that employs aspects of virtual reality technology in combination with high performing lenses and displays to enhance the user experience without the need for bulky and complicated headwear. FIG. 1 illustrates a view of the exterior form factor of the device. From FIG. 1 there is provided a monocular viewing device 101 that includes a camera 102, a speaker 103, adjustable magnification buttons 104, a microphone 105, a mode button 106, and includes a lens and display at point 107. The design does not employ a smartphone.

In one aspect, the form factor employed is on the order of 80 millimeters in length, 32 millimeters in height and 32 millimeters in depth. Other dimensions may be employed, and certain connection hardware may be offered that goes beyond the shape of the external form factor and beyond these dimensions. In one embodiment the form factor, representing the majority of the shape of the device, is less than 100 millimeters in any dimension. The present design is monocular, and as a result the largest dimension of the device is typically the length.

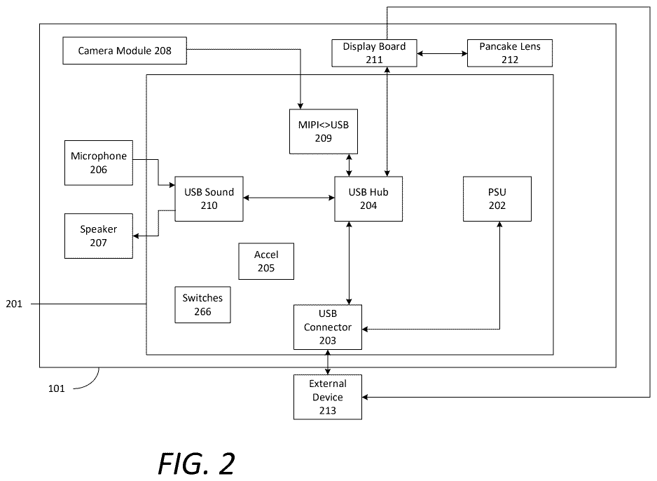

FIG. 2 is an overall representation of the system including monocular viewing device 101. A printed circuit board assembly (PCBA) 201 is provided that includes a power supply 202, a USB connector 203, such as a USB or USB-C connector, and a USB hub 204 in this embodiment. USB hub 204 in one embodiment may be USB3 compatible. An accelerometer 205 detects motion of the device, and switches 206 allow for turning on aspects of the device and control the device, including zooming in and out (plus/minus), power, and mode. Switches 206 as represented on PCBA 201 represents electrical connection between PCBA 201 and switches available on the device such as on the exterior of the form factor shown in FIG. 1.

Sound is provided via microphone 207 which receives audio and speaker 208 which transmits audio. Sound is offered to facilitate the so-called “See what I See” artificial intelligence which can be queried by the user when needed to describe to him his surroundings and/or corroborate what he sees through the display. Camera module 208 provides a camera on the front of the monocular viewing device 101 that receives visual images.

PCBA 201 may employ any appropriate protocols, and in one instance MIPI (Mobile Industry Processor Interface) may be employed in order to connect various components represented in FIG. 2. USB interface 209, which may be a MIPI to USB interface, facilitates images passing from camera module 208 to the USB hub 204. USB sound interface 210 provides an interface between microphone 206 and USB hub 204, as well as USB hub 204 and speaker 207.

Monocular viewing device 101 further includes display board 211 that interfaces between the USB hub 204 and lens or pancake lens 212 which may include or be associated with a viewfinder module as well as external computing device 213. Display board 211 provides signals and information to external computing device 213 when monocular viewing device 101 is connected to external computing device 213. External computing device 213 also provides data to USB connector 203 when connected to monocular viewing device 101.

In the arrangement represented in FIG. 2, when external computing device 213 is connected to monocular viewing device 101, monocular viewing device 101 can receive images via camera module 208 and can pass those images to external computing device 213 through the various components including USB interface 209, USB hub 204, and USB connector 203. External computing device 213 may provide processing of the images received as desired, such as processing intended for the benefit of and directed to the user. For example, external computing device 213 may add brightness, address color blindness issues where possible, and so forth. Processing may entail employing a device such as a personal computer having an available processor such as the Intel i5 or AMD Ryzen 5, which receives a USB data input and provides HDMI video output.

The system may provide the signal from external computing device 213 back to USB connector 203, to USB hub 204, and to display board 211 and to pancake lens 212 which may then be viewed by the user. The pancake lens may include a viewfinder or viewfinder module and the display arrangement, including pancake lens 212 and display board 211, may be an OLED type display or other appropriate display element. In one embodiment, the display board 211 and pancake lens 212 configuration may employ or consist of a micro-OLED display module. Any appropriate lensing arrangement that allows for clear viewing may be employed, and flat, thin lenses commonly used in camera applications may be employed. In one application, such a lens may offer diopter adjustment over a wide range, such as minus eight to plus three diopter, with an eyebox and eye relief on the order of eight by eight millimeters at a ten millimeter distance. Such a lens can provide a wide field of view, approaching 90 degrees or in the range of 80 degrees in one such application.

In one embodiment the display arrangement including display board 211 and pancake lens 212 may include a high resolution OLEDoS display with a high resolution, such as on the order of 2560×2560 with a (real RGB), but may be smaller if desired, such as 1920×1200. OLEDoS uses semiconductor technology combined with OLED functionality to provide relatively high brightness, high contrast, high pixels per inch, low response time, and low power consumption. Such an arrangement is suitable for near-eye devices such as the present design. An OLEDoS display arrangement may in one embodiment more than 3500 pixels-per-inch and a brightness in the 3000 nits range. Display board 211 processes video signals received, such as video signals processed by external computing device 213, and sends those signals for display. Again, the interface for display board 211 may be MIPI. Other technologies and display arrangements may be provided that can offer processed images appropriate for the user to the user.

With respect to camera module 208, such a module may be a high megapixel camera module such as those used with smartphones, in one embodiment a 50 megapixel module with a relatively large sensor that can capture detailed images in low light conditions and can also capture high quality video images may be employed, and camera module 208 may support 4K video recording. Camera module 208 may also employ autofocus technology and provide the ability to adjust settings such as frame rate and color grading. The interface of camera module 208 may be MIPI and camera module 208 may exhibit a field of view approaching 90 degrees.

USB hub 204 may be a low-power configurable USB controller hub with downstream ports that support the various downstream devices having various operating speeds with different embedded USB applications. USB hub 204 consolidates multiple USB connections from various components (camera, microphone, speaker) at a central point and manages power distribution and data communication between the external computing device 213 and components presented.

Accelerometer 205 may be a digital three axis linear accelerometer having antialiasing filtering capable of measuring accelerations at a range of data rates including high data rates. Power supply 202 provides sufficient power to run the components shown on PCBA 201. Microphone 206 and speaker 207 can receive spoken commands from the user and provide audio such as spoken instructions or prompts. Accelerometer 205 is used to power the device on and off. In this embodiment, when a user is wearing the monocular viewing device 101 around his neck, the monocular viewing device 101 is in a vertical orientation. When he picks it up to use it for a task, such as to see where the door is in front of him, accelerometer 205 senses movement and/or rotation and sends a signal causing the monocular viewing device to turn on. Lowering the device may, with the help of accelerometer 205, turn monocular viewing device 101 off.

In one embodiment, external computing device 213 receives images from monocular viewing device 101 and processes these images and may for example implement magnification via digital zoom before sending the final processed video signal to the display. In this configuration, the external computing device 213 may power the various components in the system via USB connection.

While shown as separate components, monocular viewing device 101 may include processing capability and may not require a separate computing device such as external computing device 213. The primary functions provided by external computing device 213 in the embodiment shown are processing of images, including providing enhancements to images received, and providing power. Display may alternatively be offered by external computing device 213, or the user may view the processed video on a display provided by external computing device 213.

The processing provided by external computing device 213, as well as the power received from external computing device 213, may instead be provided on or from monocular viewing device 101. When provided by or on monocular viewing device 101, a larger physical enclosure than shown in FIG. 1 may be required. Processing of images can require storage capability and other relevant processing related components but appropriate processing and power capabilities may be offered within monocular viewing device 101 in one embodiment. Additionally, the user may benefit from a separate significantly larger viewing display apparatus which may either be offered as part of the monocular viewing device 101 or as a separate hardware display connected or connectable to monocular viewing device 101.

In one embodiment, monocular viewing device 101 may employ a system-on-chip or system-on-module device as a processor, obviating the need for an external device such as external computing device 213. Such a system-on-chip device may offer communication and video capture and processing capabilities using small but powerful CPU and GPU devices, with in one embodiment WiFi and Bluetooth capabilities, with dimensions sized to fit within monocular viewing device 101. In one embodiment, such a device may be sized less than 50 millimeters by 50 millimeters. Memory may be provided on-chip. In such a construction, external device 213 may not be required, and other components, such as USB hub 203 may be omitted, with different connections provided such as a different connection from PSU 202 to, for example, the system-on-chip apparatus. System-on-chip apparatus (not shown) may perform many or all of the functions discussed above with respect to external device 213.

For a user perspective, the user may be in possession of monocular viewing device 101 which may be attached to an external device such as external computing device 213 or a system-on-chip as described. The user may turn on monocular viewing device 101 using a switch from among switches 206 and monocular viewing device 101 may receive visual images via camera module 208. The user may a viewfinder offered with pancake lens 212. Images received are processed by camera module 208 and sound and image information passes to and through the components shown in FIG. 2 to external computing device 213 and eventually to display board 211 and may be displayed using pancake lens 212. Sound may be received via microphone 206 and may pass with images through the components shown in PCBA 201 to, in one embodiment, external computing device 213 and to display board 211. External computing device 213 processes the information as discussed, in one embodiment adding enhancements specific to the user. Processing may include color alteration, adding brightness, and so forth. In one example, if the user has lighting sensitivities, additional light or brightness may be provided via, for example, external computing device 213. The resultant images and sound are provided back to monocular viewing device 101 and sound may be played via speaker 207. The user may make a statement or request which is received by microphone 206, and the audible request may be passed through the components shown to external computing device 213 which determines the words spoken and determines a response to the user inquiry, and the response determined may be provided to monocular viewing device 101 and played via speaker 207. Images may be either displayed via external computing device 213 or via the monocular viewing device 101 via pancake lens 212. Again, an internal system-on-chip may be employed within monocular viewing device 101 that replaces and performs many or all of the functions of external computing device 213.

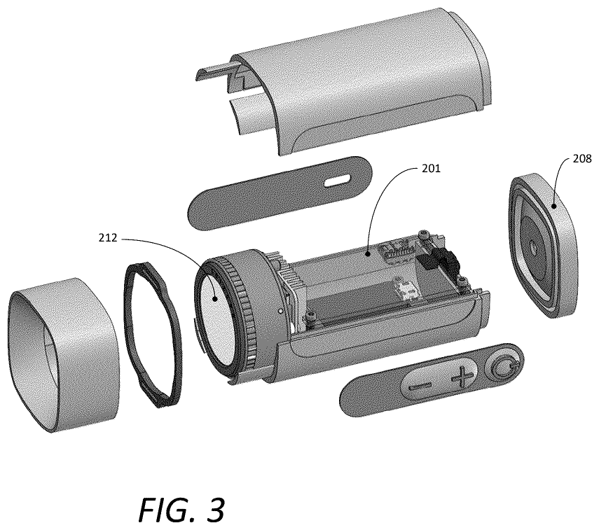

FIG. 3 shows an exploded version of one embodiment of the present design including PCBA 201 and an OLEDoS display including pancake lens 212. In one embodiment, the overall dimensions of the housing are approximately 80 millimeters by 32 millimeters by 32 millimeters, but other dimensions may be employed. In one embodiment, no dimension of the housing is greater than 100 millimeters. Certain external connection elements or fixtures provided with the housing may be provided, but any external elements are not considered part of the housing and full dimensions, including external connection elements, may exceed the 100 millimeter dimension.

The present design requires balancing between image quality, measured in such quantities as frame rate and pixels offered, versus processing capability. While USB components and protocols may be employed, USB throughput can be limited in certain instances and can pose a bottleneck when encountering significantly high quality video requirements. The system may address this by offering, for example, greyscale images, omitting sound, offering lower video resolution, varying framerate, or offering an applicable and acceptable communication protocol other than USB that provides the functions listed herein.

Thus the present design includes a monocular apparatus configured to receive images and display enhanced images, comprising a housing having length less than 100 millimeters, the housing comprising a camera module with resolution of or exceeding 50 megapixels, a printed circuit board array configured to receive image information from the camera module and provide enhanced images, and a display element configured to receive the enhanced images and display the enhanced images.

According to a further embodiment, there is provided a monocular viewing apparatus configured to receive images and display enhanced images. The monocular viewing apparatus comprises a housing having length less than 100 millimeters, the housing comprising a camera module, a printed circuit board array configured to receive image information from the camera module and provide enhanced images, a display element configured to receive the enhanced images and display the enhanced images, and audio components connected to the printed circuit board array.

According to another embodiment, there is provided an apparatus comprising a housing having length less than 100 millimeters. The housing comprises a camera module having a resolution of at least 50 megapixels, a printed circuit board array configured to receive image information from the camera module and provide enhanced images, and a display element configured to receive the enhanced images and display the enhanced images. The apparatus further comprises an external computing device connectable to the printed circuit board array and configured to enhance video image information specific to a user.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A monocular apparatus configured to receive images and display enhanced images, comprising:
a housing having length less than 100 millimeters, the housing comprising:
a camera module with resolution of or exceeding 50 megapixels;
a printed circuit board array configured to receive image information from the camera module and provide enhanced images; and
a display element configured to receive the enhanced images and display the enhanced images.

2. The monocular apparatus of claim 1, further comprising an external computing device configured to receive image information from and provide enhanced image information to the printed circuit board array.

3. The monocular apparatus of claim 2, wherein the display element comprises a display board connected to an OLED display comprising a pancake lens.

4. The monocular apparatus of claim 1, wherein the printed circuit board array employs USB functionality.

5. The monocular apparatus of claim 4, wherein the printed circuit board array further employs MIPI (Mobile Industry Processor Interface) functionality.

6. The monocular apparatus of claim 2, wherein the external computing device enhances image information in a manner specific to a user.

7. The monocular apparatus of claim 1, wherein the housing further comprises both a microphone and a speaker connected to the printed circuit board array and the printed circuit board array processes and provides audio information.

8. The monocular apparatus of claim 3, wherein the pancake lens provides a field of view in excess of seventy degrees.

9. A monocular viewing apparatus configured to receive images and display enhanced images, comprising:
a housing having length less than 100 millimeters, the housing comprising:
a camera module;
a printed circuit board array configured to receive image information from the camera module and provide enhanced images;
a display element configured to receive the enhanced images and display the enhanced images; and
audio components connected to the printed circuit board array.

10. The monocular viewing apparatus of claim 9, further comprising an external computing device configured to receive image information from and provide enhanced image information to the printed circuit board array.

11. The monocular viewing apparatus of claim 10, wherein the display element comprises a display board connected to an OLED display comprising a pancake lens.

12. The monocular viewing apparatus of claim 10, wherein the printed circuit board array employs USB functionality.

13. The monocular viewing apparatus of claim 12, wherein the printed circuit board array further employs MIPI (Mobile Industry Processor Interface) functionality.

14. The monocular viewing apparatus of claim 10, wherein the external computing device is configured to enhance image information in a manner specific to a user.

15. The monocular viewing apparatus of claim 9, wherein the audio components comprise a microphone and a speaker connected to the printed circuit board array and the printed circuit board array processes and provides audio information.

16. The monocular apparatus of claim 11, wherein the pancake lens provides a field of view in excess of seventy degrees.

17. An apparatus comprising:
a housing having length less than 100 millimeters, the housing comprising:
a camera module having a resolution of at least 50 megapixels;
a printed circuit board array configured to receive image information from the camera module and provide enhanced images; and
a display element configured to receive the enhanced images and display the enhanced images; and
an external computing device connectable to the printed circuit board array and configured to enhance video image information specific to a user.

18. The apparatus of claim 17, wherein the display element comprises a display board connected to an OLED display comprising a pancake lens.

19. The apparatus of claim 17, wherein the printed circuit board array employs USB and MIPI (Mobile Industry Processor Interface) functionality.

20. The apparatus of claim 17, wherein the housing further comprises both a microphone and a speaker connected to the printed circuit board array and the printed circuit board array processes and provides audio information.
